(19) United States
(12) Patent Application Publication
(10) Pub. No.: US 2026/0275182 A1
(43) Pub. Date: Sep. 17, 2026

(54) HIGH PERFORMANCE EXPANDABLE LINER HANGER USING HYDROSTATIC ASSIST BY CHEMICALLY MODIFYING LINER HANGER ENVIRONMENT

(71) Applicant: Halliburton Energy Services, Inc., Houston, TX (US)

(72) Inventors: Paul J. Jones, Houston, TX (US); Atharv Abhijit Naik, Singapore (SG); Jalpan P. Dave, Singapore (SG)

(21) Appl. No.: 19/081,776

(22) Filed: Mar. 17, 2025

(51) Int. Cl. C09K 8/42; C04B 14/02; C04B 20/00; E21B 43/10

(52) U.S. Cl. CPC C09K 8/422; C04B 14/022; C04B 20/0028; C04B 20/0032; C04B 20/0036; C04B 20/004; E21B 43/103

(57) ABSTRACT

Embodiments of a composition and methods are disclosed herein. In one embodiment, a composition comprises a fluid configured to be pumped into a wellbore between a liner hanger and a casing, the fluid containing an additive configured to rupture when compressed.

### TECHNICAL FIELD

The disclosure generally relates to the field of subsurface operations and, more specifically, to liner hangers for use in geothermal and extreme subterranean environments.

### BACKGROUND

Liner hanger systems may be used in subsurface wells to extend a liner from the bottom of a cemented casing string. Traditional expandable liner hangers may use elastomeric sealing elements in their construction. For example, an elastomeric sealing element may be used between the anchoring grips or spikes designed into the metallic body of the liner hanger. The elastomeric sealing element may include an elastomeric ring positioned circumferentially around the liner hanger body, the elastomeric ring configured to form a fluidic seal and to provide mechanical support to the anchoring spikes. The elastomeric elements traditionally contact an internal surface of a downhole casing via expansion. Some downhole environments may experience higher pressure (such as 17 ksi) than and higher loads (2300 klbf). Currently available liner hanger systems are unable to be used in these anticipated high pressure downhole environments and achieve these ratings.

### BRIEF DESCRIPTION OF THE DRAWINGS

Aspects of the disclosure may be better understood by referencing the accompanying drawings.

FIG. 1 is a schematic depicting a vertical section of an example well system, according to some implementations.

FIGS. 2A and 2B are side views of a portion of a liner hanger and casing, according to some implementations.

FIG. 3 is chart illustrating example bead additives that may be used as rupturing additives in the system and method, according to some implementations.

FIG. 4 is a flowchart depicting a method, according to some implementations.

FIG. 5 is a flowchart depicting another method, according to some implementations.

### DETAILED DESCRIPTION

The description that follows includes example systems, methods, techniques, and operational flows that embody aspects of the disclosure. However, this disclosure may be practiced without these specific details. For clarity, some well-known structures and techniques have been omitted.

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms.

Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to a direct interaction between the elements and may also include an indirect interaction between the elements described. Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

In some downhole environments, tools and elements may experience extremely high temperatures and pressures, such as pressures greater than 10,000 psi. In traditional expandable liner hanger (ELH) systems, fluid, such as from cement slurry, may be trapped between each spike of the hanger and the casing once the liner hanger is expanded. Computational Fluid Dynamics (CFD) shows the hydrostatic pressure due to this trapped fluid is about 90% of the hydrostatic pressure at the hanger depth before expansion. The tubing hydrostatic pressure remains same so there is about a 10% differential after expansion from tubing to the annulus side. This high pressure may make maintaining a good seal between the spikes and casing difficult as the sealability of some spikes are limited by the inherent collapse strength of the hanger body under a combined pressure load, which could lead to sudden opening of the clearance between a wellbore casing and hanger body outer diameter (OD).

In the proposed method, a rupturing additive, such as hollow glass microsphere (beads) may be used in the fluid environment between the liner hanger and the casing before setting the liner hanger so that upon expansion of the liner hanger, the beads rupture causing the trapped fluid to now fill a greater volume. This results in regulating the pressure in the outer annulus side of the hanger between each spike and between the liner hanger and the casing. The pressure from fluid compression may be reduced by compensating for the compressed volume between the liner hanger and the casing interior wall by the void volume of the rupturing additive. For example, water at 200° F. under a hydrostatic pressure of 4000 psi may have a specific gravity of 0.97527. Upon compression to 20000 psi the specific gravity of water at 200° F. may increase to 1.0173. This corresponds to a compression volume of about 1.7%. To compensate for the compressed volume a hollow glass sphere with a 4000 psi pressure rating such as HGS 4000 may be included. HGS 4000 with a specific gravity of 0.38 and has an approximate void volume of 85%. On a per barrel basis 0.017 bbl of void volume from the beads should be included to maintain pressure at 4000 psi and compensate for fluid compression. This corresponds to 0.02 bbl of HGS 4000 or 2.5 lb. of HGS 4000. See for example, Table 1 below.

TABLE 1
Isothermal Data for T = 200.00 F in liquid phase water

| | | | Internal | | | | | Sound | Joule- | | Therm. |
|---|---|---|---|---|---|---|---|---|---|---|---|
| Pressure | Density | Volume | Energy | Enthalpy | Entropy | Cv | Cp | Spd. | Thomson | Viscosity | Cond. |
| (psia) | (g/ml) | (ml/g) | (kJ/mol) | (kJ/mol) | (J/mol*K) | (J/mol*K) | (J/mol*K) | (m/s) | (F/psia) | (uPa*s) | (W/m*K) |
| 4000 | 0.97527 | 1.0254 | 6.9167 | 7.4261 | 21.827 | 67.73 | 74.785 | 1603.9 | −0.0023046 | 309.97 | 0.68939 |
| 5000 | 0.9782 | 1.0223 | 6.887 | 7.5219 | 21.741 | 67.545 | 74.55 | 1617.2 | −0.0023141 | 311.8 | 0.69304 |
| 6000 | 0.98109 | 1.0193 | 6.8582 | 7.6178 | 21.657 | 67.365 | 74.323 | 1630.4 | −0.002323 | 313.63 | 0.69665 |
| 7000 | 0.98392 | 1.0163 | 6.8301 | 7.7138 | 21.574 | 67.189 | 74.105 | 1643.3 | −0.0023313 | 315.44 | 0.70022 |
| 8000 | 0.98672 | 1.0135 | 6.8027 | 7.8098 | 21.492 | 67.016 | 73.894 | 1656.1 | −0.0023392 | 317.26 | 0.70376 |
| 9000 | 0.98947 | 1.0106 | 6.776 | 7.9058 | 21.411 | 66.848 | 73.69 | 1668.7 | −0.0023465 | 319.07 | 0.70726 |
| 10000 | 0.99218 | 1.0079 | 6.75 | 8.0019 | 21.331 | 66.683 | 73.493 | 1681.1 | −0.0023534 | 320.88 | 0.71072 |
| 11000 | 0.99485 | 1.0052 | 6.7246 | 8.098 | 21.252 | 66.522 | 73.303 | 1693.3 | −0.0023599 | 322.69 | 0.71415 |
| 12000 | 0.99748 | 1.0025 | 6.6998 | 8.1941 | 21.174 | 66.365 | 73.119 | 1705.4 | −0.0023661 | 324.49 | 0.71755 |
| 13000 | 1.0001 | 0.99993 | 6.6756 | 8.2902 | 21.097 | 66.211 | 72.941 | 1717.4 | −0.0023718 | 326.3 | 0.72091 |
| 14000 | 1.0026 | 0.99738 | 6.6519 | 8.3863 | 21.021 | 66.061 | 72.769 | 1729.1 | −0.0023773 | 328.11 | 0.72424 |
| 15000 | 1.0052 | 0.99487 | 6.6288 | 8.4824 | 20.945 | 65.914 | 72.602 | 1740.8 | −0.0023824 | 329.91 | 0.72754 |
| 16000 | 1.0076 | 0.99242 | 6.6062 | 8.5785 | 20.871 | 65.77 | 72.441 | 1752.3 | −0.0023872 | 331.72 | 0.73081 |
| 17000 | 1.0101 | 0.99 | 6.5841 | 8.6746 | 20.797 | 65.63 | 72.284 | 1763.6 | −0.0023917 | 333.53 | 0.73405 |
| 18000 | 1.0125 | 0.98763 | 6.5625 | 8.7706 | 20.724 | 65.493 | 72.132 | 1774.9 | −0.002396 | 335.34 | 0.73726 |
| 19000 | 1.0149 | 0.9853 | 6.5413 | 8.8666 | 20.651 | 65.359 | 71.985 | 1786 | −0.0024 | 337.16 | 0.74045 |
| 20000 | 1.0173 | 0.98301 | 6.5206 | 8.9626 | 20.58 | 65.228 | 71.842 | 1797 | −0.0024038 | 338.98 | 0.7436 |

(Source of Data: National Institute of Standards and Technology (NIST): Thermophysical Properties of Fluid Systems (https://webbook.nist.gov/chemistry/fluid))

The pressure differential continually pushes the liner hanger outward toward the casing for an improved seal. The disclosed solution will improve liner hanger performance thus resulting in the ability to design hangers to higher downhole pressure ratings and loads than traditional liner hangers.

To effectively place the fluid containing the rupturing additive in the region between the liner hanger and the casing wall, the density of the fluid may be adjusted by inclusion of a density modifying agent. The density modifying agent may comprise barite, hematite, ilmenite, manganese tetraoxide or combinations thereof.

The fluid containing the rupturing additive may additionally contain rheology modifiers to promote suspension solids and prevent flotation of rupturable particles. Specifically, rheology modifiers increase the yield point of the fluid to counteract buoyant forces leading to floatation or sedimentation during the time frame between placement and setting of the liner hanger. The rheology modifier may include bentonite, attapulgite, xanthan gum, welan gum, diutan gum, synthetic polymers or combinations thereof.

In cases where the fluid rupturing additive is too viscous for placement, a dispersant may be added to the system containing the rupturable additive to improve flow and reduce viscosity. The dispersant may be selected from lignosulfonates, polycarboxylates, naphthalene sulfonates, melamine sulfonates or combinations thereof.

### Example System

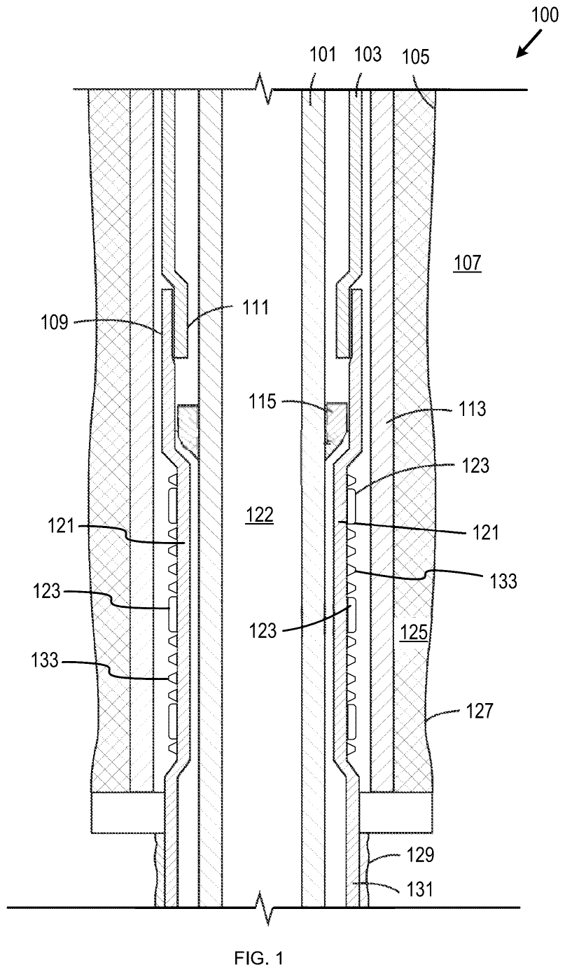

FIG. 1 is a longitudinal section 100 diagram depicting an example expandable liner hanger system, according to some implementations. A wellbore 105 may be drilled through a subsurface formation 107. The wellbore 105 may be at least partially cased by a casing 113 that defines a cased section 127. The casing 113 may be cemented in the wellbore 105 by cement 125. A lower section 129 of the wellbore 105 may include a liner 131 and a tubing workstring 101 that extend into the lower section 129. The liner 131 may hang from a lower end of the casing 113 via an expandable liner hanger 121.

The expandable liner hanger 121 may include a plurality of anchoring grips or spikes 133 and one or more sealing elements 123 positioned circumferentially around an exterior of the expandable liner hanger 121. An upper portion of the expandable liner hanger 121 may be joined to a tie back receptacle 103 via a threaded joint 109. The expandable liner hanger 121 may include a larger inner diameter than an outer diameter of a tapered section 111 of the tie back receptacle 103. However, other implementations may use a different means of coupling the expandable liner hanger 121 and tie back receptacle 103 than the threaded joint 109.

The expandable liner hanger 121 may be expanded to sealingly engage with the casing 113 via a setting tool, such as expansion cone 115 to create an interference fit with the casing 113. The expansion cone 115 may be conveyed into the wellbore 105 via the tubing string 101. Fluidic pressure applied from the surface may push the expansion cone 115 through the expandable liner hanger 121. This may expand the outer diameter of the expandable liner hanger 121, and the anchoring spikes 133 and sealing elements 123 may contact the inner wall of the casing 113 to form the seal. In some implementations, the one or more sealing elements 123 may include an exterior sealing surface configured to contact the casing 113.

The anchoring spikes 133 may be metallic anchoring spikes comprised of one or more metals, alloys, or any other suitable material. For example, the anchoring spikes 133 may be comprised of any suitable steel grade, aluminum, any other ductile material, any combination thereof, etc. Each anchoring spike 133 may be a circular ring that positioned circumferentially around an outer diameter of the expandable liner hanger 121, although other configurations, spacings, quantities, and surface geometries of the anchoring spikes 133 may be possible. Each of the anchoring spikes 133 may provide a metal-to-metal seal between the expandable liner hanger 121 and an inner surface of the casing 113.

In typical wellbore environments, pressure in annulus 122 within the tubing may be similar to the pressure external to casing 113. Sealing elements prevent fluid and/or pressure from weakening the seal between the spikes 133 and the casing 113 and to hydraulically isolate the wellbore below the liner. Additional sealing capability may be achieved by the sealing elements 123. The seal formed with the casing 113 may be a fluidic seal, a pressure seal, a mechanical seal, etc. One or more sealing elements 123 may be placed between a section of the anchoring spikes 133 to form the seal, increase the anchoring load of the expandable liner hanger 121, provide pressure integrity to the seal between the expandable liner hanger 121 and the casing 113, etc. In addition to or in place of the sealing elements 123, a pressure differential created between annulus between the liner hanger and the casing 113 and the tubing annulus 122 may provide additional sealing capabilities for the liner hanger 121.

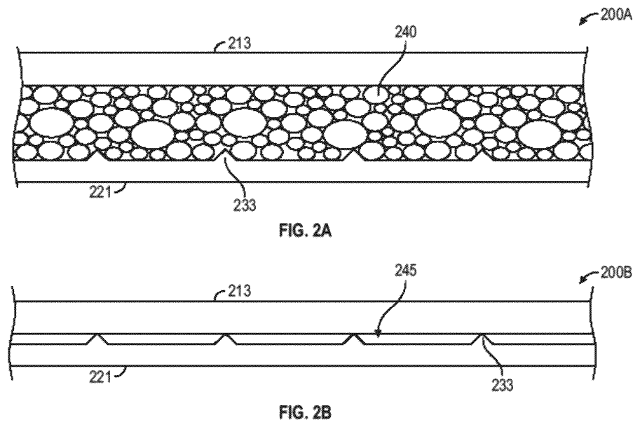

FIGS. 2A and 2B are side views of a portion of a liner hanger system 200 according to some embodiments. The system 200 includes a liner hanger 221, which may be similar in construction and placement as liner hanger 221. The liner hanger 221 includes a plurality of anchoring spikes 233 or grips, which may engage an inner wall of casing 213 once expanded outward. A fluid may be pumped into the wellbore for cementing the liner hanger 221 in place. The fluid, in some embodiments, may be a cement slurry mix and include an additive that is configured to rupture in response to compression. The additive may be a rupturing additive and comprise a plurality of rupturing structures, such as hollow glass microspheres (beads), cenospheres (floaters in fly ash), ceramic microspheres, and combinations thereof. In the illustrated embodiment, the additive is shown as hollow beads 240 (microspheres). The beads 240 may be hollow glass beads configured to rupture as physical compression is applied to the fluid. The beads 240 may differ for different wellbore environments and may be selected for each wellbore based on the expected bottom hole temperature and pressure environment in the wellbore. In some implementations, that ratio of beads to cement is a mass of beads (lb.) per volume of fluid (bbl). The mass of beads per volume of fluid may be between 0.05 to 50 lb./bbl.

As the liner hanger 221 and spikes 233 are pushed outward toward the casing 213 by an expansion tool, such as an expansion cone 115, the physical compression on the beads 240 by the liner hanger 221 causes the beads 240 to rupture and volume is gained back in the compressed fluid, causing a pressure drop in the annulus 245 between the liner hanger 221 and casing 213, shown in FIG. 2B. In some examples, the pressure of the fluid prior to liner hanger expansion may be about 90% of the initial hydrostatic pressure in the tubing annulus. The tubing hydrostatic pressure in the tubing annulus is generally about equal to the hydrostatic pressure in the external annulus (external to the casing 213). As the beads 240 rupture, the pressure in the fluid and annulus 245 between the hanger 221 and casing 213 is substantially reduced, down to about 20% or less of the initial hydrostatic pressure, and in some implementations, near zero of the initial hydrostatic pressure, minimizing any pressure rise due to fluid compression between the spikes 233. The contact between the spikes 233 and the casing 213 gives the liner hanger the ability to seal pressure from uphole/above or downhole/below the liner hanger and allows the liner hanger 221 to anchor in place. When there is a low or near zero pressure in the annulus 245 between the spikes 233 and casing 213, the pressure differential results in the pressure inside the wellbore tubing to continually push and energize the hanger 221 radially outward, therefore maintaining a better seal between the spikes 233 and the casing 213. The lack of pressure in the annulus 245 enables the liner hanger system 200 to have a higher differential pressure rating and a higher anchoring rating.

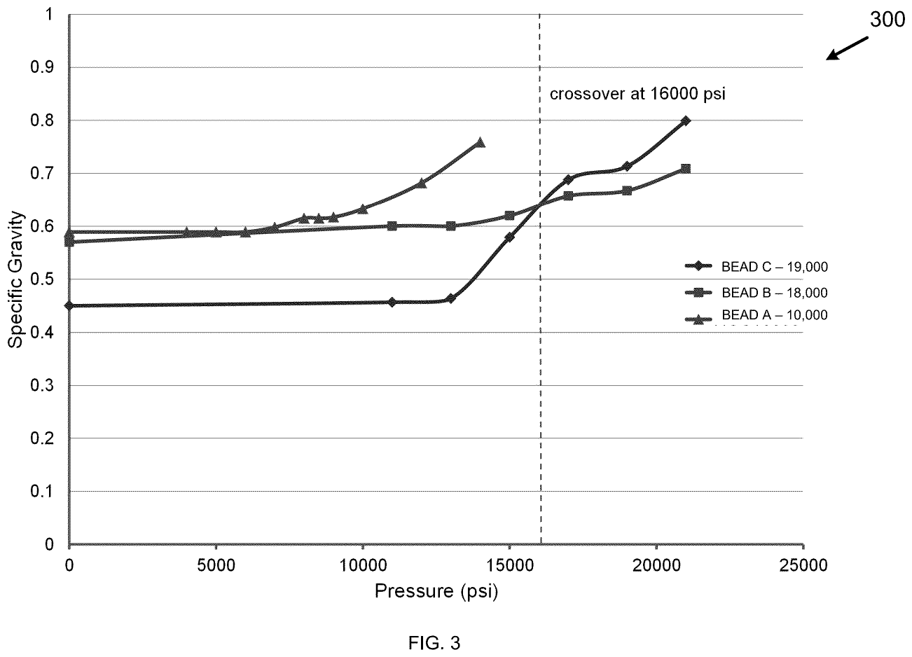

The beads 240 may be selected according to the anticipated pressure in the bottom hole environment in the wellbore. The rupture pressure can be adjusted based on the selected beads. FIG. 3 is a chart 300 illustrating example beads that may be used as the additive in the fluid. The example beads each have different pressure ratings versus specific gravity. In the provided examples, a first bead may be rated for at least 1,0000 PSI (68.95 Bar) and a second bead rated 10,000 PSI (689.48 Bar). A third bead may be rated for 18,000 PSI (1241.06 Bar), and a fourth bead may be rated for 19,000 PSI (1310 Bar). As the cement slurry is pumped into the wellbore, the beads can withstand rupturing at these pressure ratings, and are then ruptured in response to compression. The beads 240 rupture and the pressure in the fluid slurry drops as physical compression is applied by expanding the liner hanger 221 radially outward. The pressure rating for the beads is based on a pressure at which about 80% or more of the beads survive when exposed to the designated pressure, based on the specific gravity of the fluid. There is a distribution in the pressure at which the additives will crush. The rating may be defines as at the point where 80% of the microspheres (beads) survive. As the pressure ratings move higher, the wall of the microspheres (bead) becomes thicker, and less volume is given back to the fluid upon rupture.

To place the beads 240 in the fluid environment around the hanger 221, the hollow glass beads/spheres 240 may be incorporated into a fluid mix, such as cement slurry that is pumped into the wellbore annulus between a previous casing shoe and the hanger. The volume fraction of beads incorporated into the cement slurry may be such that their hollow core volume compensates for the compressed fluid in the hanger region. The pressure rating of the beads 240 should be greater than an expected maximum bottom hole pressure that may be encountered during the cementing operation. In addition to placement in the fluid mixture, in some implementations, the beads 240 may also be incorporated into spacers, completion fluids, and drilling muds.

If the cement is poured to be brought above the top of liner, then the beads 240 will be placed into the cement slurry. If the cement is not brought above the liner, then the beads 240 may be placed into spacers. If the spacers are not brought above the liner, then the beads 240 may be added into the drilling fluid in the space between the liner hanger 221 and the casing 213.

In an alternate embodiment, a gas generating additive is incorporated into the cement slurry or fluid instead of using hollow beads. The gas generating additive may comprise aluminum powder. In still other embodiments, the cement slurry or fluid may comprise nitrogen. And in some other embodiments, the cement slurry or fluid may comprise compressible carbon particles. The compressible carbon particles may be a plurality of carbon particles are held together by a matrix of cross-linked binder. A foam or rubber composite houses the compressible particles by impregnating them into a cross-linked polymer matrix. Preferably, the particles are just blended with a binder to form a solid sheet. The binder may be, for example, silicone, nitrile butadiene rubber (NBR), fluoroelastomer (such as FKM) or hydrogenated nitrile butadiene rubber (HNBR), providing a compressible solid filler. Alternatively, a thermoset or thermoplastic (or soft plastic) material is used as the binder. The sheet is inert to the heated wellbore fluids.

### Example Methods

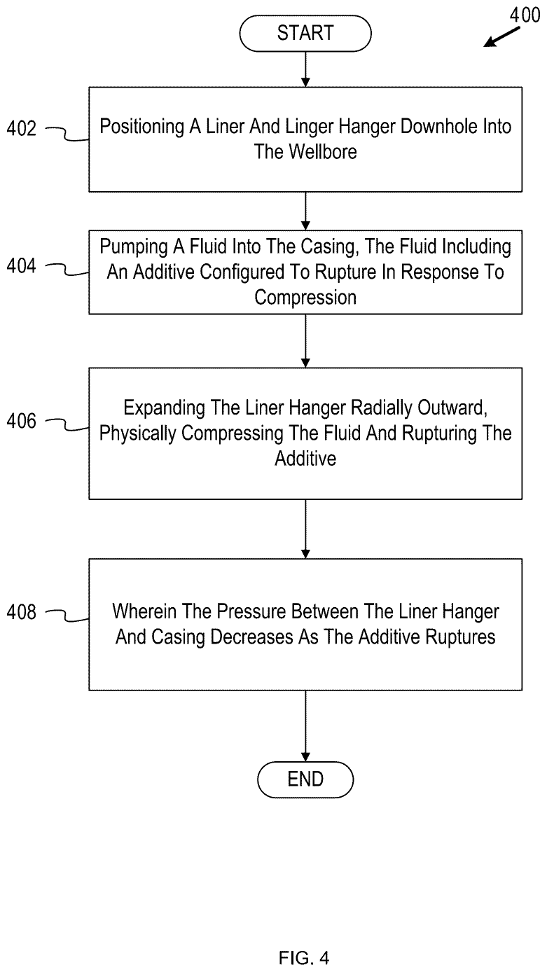

FIG. 4 is a flowchart illustrating a method 400, according to the disclosure.

The method begins at a block 402 positioning a liner system with a liner hanger into a wellbore downhole of the previous casing shoe.

The method continues at a block 404, pumping a fluid solution, such as a cement slurry, into the wellbore at least into an annulus between a previous casing shoe and location for a next liner and into an annulus between the liner hanger and the casing. The fluid solution may include an additive, such as a plurality of hollow glass beads, configured to rupture in response to physical compression.

The method continues at a block 408 physically expanding the liner hanger radially outward toward the casing, physically compressing the fluid and rupturing the fluid.

At a block 410, a pressure in the annulus between the liner hanger and the casing decreases as the additive ruptures, creating a pressure differential across the liner hanger.

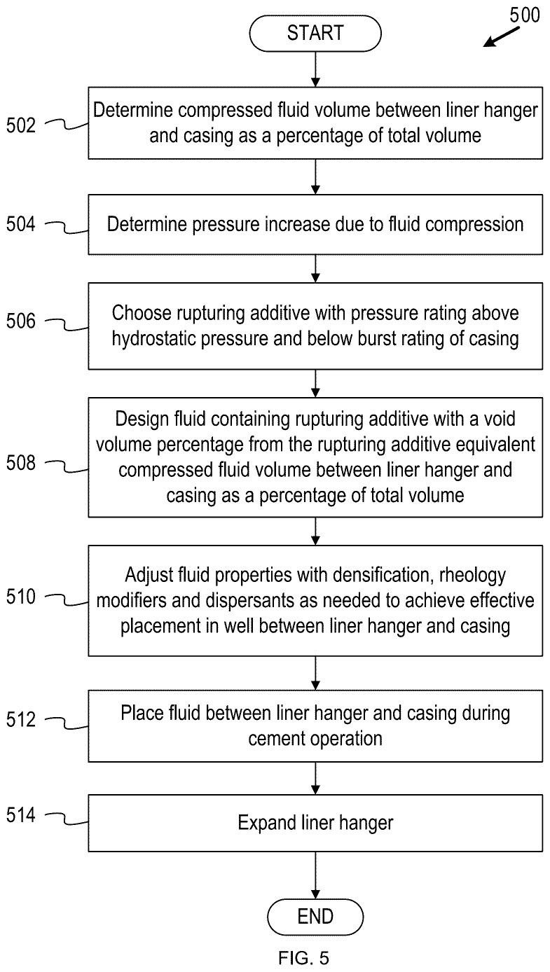

Referring to FIG. 5, there is another flowchart illustrating a method 500. The method begins at a block 502, determining a compressed fluid volume between a liner hanger and a casing in a wellbore as a percentage of total volume.

The method continues at a block 504, determining a pressure increase due to fluid compression in the wellbore.

The method continues at a block 506, choosing a rupturing additive with a pressure rating above hydrostatic pressure and below a burst rating of the casing. The rupturing additive may include includes at least one of a combination of a plurality of glass microspheres, cenospheres, ceramic microspheres, or a combination thereof.

The method continues at a block 508, designing a fluid containing the chosen rupturing additive with a void volume percentage from the rupturing additive that is equivalent to the compressed fluid volume between the liner hanger and the casing as a percentage of total volume.

At a block 510, the fluid properties may be adjusted with at least one of a densification, rheology modifiers and dispersants as needed to achieve effective placement in well between the liner hanger and the casing.

At a block 512, the fluid is placed between the liner hanger and the casing during a cementing operation.

At a block 514, the liner hanger is expanded, compressing the fluid and rupturing the additive in the fluid.

The above disclosed system and methods may be used with any liner hanger system and configuration where the liner hanger is physically expanded or compressed outward into engagement with the casing.

As used herein, the term “or” is inclusive unless otherwise explicitly noted. Thus, the phrase “at least one of A, B, or C” is satisfied by any element from the set {A, B, C} or any combination thereof, including multiples of any element.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, and the principles and the novel features disclosed herein.

The various implementations may include some implementations that have all or any combination of the aspects described herein. An implementation can include any one or more of the aspects described herein. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations.

In certain circumstances, multitasking and parallel processing may be advantageous. Additionally, other implementations are within the scope of the following claims. In some cases, the actions recited in the claims may be performed in a different order and still achieve desirable results.

### EXAMPLE EMBODIMENTS

Aspects disclosed herein include:
Aspect A: A composition for use within a wellbore, comprising: a fluid pumped into the wellbore at least partially between a liner hanger and the wellbore casing, the fluid containing an additive configured to rupture when compressed.
Aspect B: A method comprising: pumping a fluid into a wellbore casing at least between a liner hanger and the casing, the fluid containing an additive configured to rupture when compressed.
Aspect C: A method comprising: determine a compressed fluid volume between a liner hanger and a casing as a percentage of total volume; determine a pressure increase due to fluid compression; choose a rupturing additive with a pressure rating above hydrostatic pressure and below a burst rating of the casing; design a fluid for placement between a liner hanger and a casing, the fluid containing the rupturing additive with a void volume percentage from the rupturing additive equivalent compressed fluid volume between the liner hanger and casing as a percentage of total volume; and place the fluid between the liner hanger and the casing.

Aspects A, B, and C may have one or more of the following additional elements in combination:
Element 1: wherein the additive includes a plurality of hollow glass beads.
Element 2: wherein a ratio of beads to fluid is a mass of beads per volume of fluid, and the mass of beads per volume may be between about 0.05 to 50 lb./bbl.
Element 3: wherein the hollow glass beads are pressure rated to at least 1000 psi
Element 4: wherein the hollow glass beads are pressure rated to at least 10000 psi
Element 5: wherein the hollow glass beads are pressure rated to at least 19000 psi
Element 6: wherein the fluid further comprises a densification modifier, a rheology modifier or a dispersant.
Element 7: wherein the additive is configured to withstand temperatures between 0-177 degrees Celsius.
Element 8: wherein the additive includes a combination of a plurality of glass microspheres, cenospheres, and ceramic microspheres.
Element 9: wherein the additive is a gas generating additive.
Element 10: wherein the additive includes compressible carbon particles.
Element 11: wherein the additive includes at least one of a combination of a plurality of glass microspheres, cenospheres, ceramic microspheres, or a combination thereof.
Element 12: wherein the additive includes one of a gas generating additive and compressible carbon particles.
Element 13: further comprising adjusting the fluid properties with at least one modifier.
Element 14: wherein the at least one modifier is a densification modifier, a rheology modifier or a dispersant

1. A composition comprising:
a fluid configured to be pumped into a wellbore between a liner hanger and a casing, the fluid containing an additive configured to rupture when compressed by expansion of the liner hanger.

2. The composition according to claim 1, wherein the additive includes a plurality of hollow glass beads.

3. The composition according to claim 2, wherein a ratio of beads to fluid is a mass of beads per volume of fluid, and the mass of beads per volume may be between about 0.05 to 50 lb./bbl.

4. The composition according to claim 2, wherein the hollow glass beads are pressure rated to at least 1000 psi.

5. The composition according to claim 2, wherein the hollow glass beads are pressure rated to at least 19000 psi.

6. The composition according to claim 1, wherein the fluid further comprises a densification modifier, a rheology modifier or a dispersant.

7. The composition according to claim 1, wherein the additive is configured to withstand temperatures between 0-177 degrees Celsius.

8. The composition according to claim 1, wherein the additive includes a combination of a plurality of glass microspheres, cenospheres, and ceramic microspheres.

9. The composition according to claim 1, wherein the additive is a gas generating additive.

10. The composition according to claim 1, wherein the additive includes compressible carbon particles.

11. A method comprising:
pumping a fluid including hollow glass beads into a wellbore between a liner hanger and a wellbore casing;
expanding the liner hanger into the wellbore casing to rupture the hollow glass beads and increase a volume of the fluid and reduce pressure between the liner hanger and the wellbore casing.

12. (canceled)

13. The method according to claim 12, wherein the hollow glass beads are pressure rated to at least 1,000 psi.

14. The method according to claim 11, wherein the hollow glass beads include at least one of a combination of a plurality of glass microspheres, cenospheres, ceramic microspheres, or a combination thereof.

15. The method according to claim 11, wherein each of the hollow glass beads includes one of a gas generating additive and compressible carbon particles.

16. A method comprising:
determining a compressed fluid volume between a liner hanger and a casing as a percentage of total volume;
determining a pressure increase due to fluid compression;
injecting, between the liner hanger and the casing, a fluid including a rupture additive having a pressure rating above hydrostatic pressure and below a burst rating of the casing and also having a void volume percentage equivalent to the compressed fluid volume between the liner hanger and the casing as a percentage of total volume; and
expanding a liner hanger into the casing to rupture the rupture additive,
placing the fluid between the liner hanger and the casing.

17. The method according to claim 16, further comprising adjusting properties of the fluid with at least one modifier.

18. The method according to claim 17, wherein the at least one modifier is a densification modifier, a rheology modifier or a dispersant.

19. The method according to claim 16, wherein the rupturing additive is a plurality of hollow glass beads.

20. The method according to claim 16, wherein the rupturing additive includes at least one of a combination of a plurality of glass microspheres, cenospheres, ceramic microspheres, or a combination thereof.
